(19) United States
(12) Patent Application Publication
(10) Pub. No.: US 2022/0237525 A1
(43) Pub. Date: Jul. 28, 2022

(54) SYSTEM AND METHOD FOR MODIFYING AN EXISTING RENTAL RESERVATION

(71) Applicant: HOWARD JAFFE, WALNUT CREEK, CA (US)

(72) Inventor: HOWARD JAFFE, WALNUT CREEK, CA (US)

(73) Assignee: PRIVATE NEGOTIATOR LLC, PACIFICA, CA (US)

(21) Appl. No.: 17/156,519

(22) Filed: Jan. 22, 2021

(51) Int. Cl. G06Q 10/02; G06Q 30/06

(52) U.S. Cl. CPC G06Q 10/02; G06Q 30/0645; G06Q 20/047; G06Q 30/0617; G06Q 30/0621

(57) ABSTRACT

A computer-implemented method, computer program, and system for modifying the start time or the end time for an existing reservation of a good or service are provided.

### FIELD

The present disclosure relates to a system and method for providing dynamic add-on options for an early start and/or late end to a rental period for a rented good or service.

### BACKGROUND

Existing systems allow a customer to reserve an item for rent for a period of time. But once the item has been reserved and the customer and agent for the item have received their confirmation communications, the systems do not allow the customer to see a full range of possible start and/or end time adjustments to the rental period without first contacting the agent (electronically, verbally, or otherwise) to review and discuss the request. As such, the existing processes require active engagement from the agent to modify a start and/or end time if such an adjustment is even acceptable for the item to be rented. Existing processes can therefore disrupt the agent and the customer is often delayed in getting a response, which itself rarely expresses the full range of possible start and/or end time adjustments to the rental period an agent would allow. For example, companies like Airbnb, Inc. have over one million guest check-in/check-out events per day, and approximately 15-20% of the guests request an early check in or a late check out. When an agent (e.g., homeowner) receives such a request, they have to respond to the inquiry while considering other issues such as, e.g., whether the home has been cleaned yet. Next, the agent would have to communicate when the earliest time would be for check-in or when the latest time is a late check-out. Next, they agent would have to request payment through some means. For at least these reasons, there is a need for an automated system and method for modifying the start time and/or end time of an existing reservation in a dynamic way that is convenient for customers and non-disruptive for agents.

### SUMMARY

In various embodiments, a computer implemented method is provided. The method can comprise: receiving an indication that a customer wants to modify an existing reservation for an item to be rented; presenting a customer interface including a feature for requesting an input of a customer identifier, wherein the customer identifier includes a plurality of attributes for the customer having the existing reservation; presenting a customer interface including a feature for requesting an input of a reservation identifier, wherein the reservation identifier includes a plurality of attributes for the item to be rented, including item name, rental start datetime, and rental end datetime; presenting a customer interface including one or more features for requesting a selection of one or more predetermined options for modifying the one or more of the plurality of attributes for the item to be rented, wherein the one or more predetermined options include modifying the rental start datetime, modifying the rental end datetime, and modifying the rental start datetime and the rental end datetime; receiving an indication that an option of the one or more predetermined options has been selected, presenting a customer interface for the selected option including a feature providing one or more alternative start datetimes, a feature providing one or more alternative end datetimes, or a feature providing one or more alternative start datetimes and one or more alternative end datetimes; receiving an input that an alternative start datetime of the one or more alternative start datetimes has been selected, that an alternative end datetime of the one or more alternative end datetimes has been selected, or that each of an alternative end datetime of the one or more alternative start datetimes and an alternative end datetime of the one or more alternative end datetimes have been selected; presenting a customer interface including one or more features for receiving a payment for the selected alternative start datetime, the selected alternative end datetime, or each of the selected alternative start and the selected alternative end datetime; receiving an indication that the payment for the selected option has been received or not received; presenting a customer interface including one or more features for indicating receipt or non-receipt of the payment, wherein: if the indication is non-receipt, then the method repeats: presenting the customer interface including one or more features for receiving a payment for the indicated modification of the one or more attributes; receiving an indication that the payment has been received or not received; and presenting the customer interface including one or more customer interface features for indicating receipt or non-receipt of the payment; until receiving an indication that the payment has been received; and transmitting a communication to the customer and an agent associated with the item to be rented, comprising information confirming the existing reservation has been modified.

In some embodiments, the communication can further comprise information identifying the one or more attributes that has been modified.

In some embodiments, each of the one or more alternative start datetimes and each of the one or more alternative end datetimes may have an associated fee that can be, independent from one another, the same or different than a fee associated with any other alternative start datetime or alternative end datetime for the item to be rented.

In some embodiments, the one or more predetermined options can be predetermined by the agent associated with the item to be rented.

In some embodiments, each of the rental start datetime, the rental end datetime, the one or more alternative start datetimes, and the one or more alternative end datetimes can be, independent from one another, predetermined by the agent associated with the item to be rented.

In some embodiments, each of the rental start datetime, the rental end datetime, the one or more alternative start datetimes, and the one or more alternative end datetimes can be, independent from one another, identical or different for each day of a year.

In some embodiments, each of the rental start datetime, the rental end datetime, the one or more alternative start datetimes, and the one or more alternative end datetimes can be, independent from one another, identical or different for a plurality of items to be rented.

In some embodiments, the item to be rented according to the existing reservation is selected from real property, personal property, or a service.

In some embodiments, the existing reservation can be created through a web application or a mobile application.

In some embodiments, the method can operate within the web application or mobile application.

In various embodiments, a computer program product comprising a non-transitory computer readable storage medium having program instructions embodied therewith, the program instructions executable by a computer processor to cause the computer processor to perform a method described herein is provided.

In various embodiments, a system for modifying an existing reservation for an item to be rented, comprising: at least one computing device in operable communication with a network; a memory that stores computer-executable components; a processor that executes the computer-executable components stored in the memory, wherein the computer-executable components comprise: an agent module providing one or more agent interfaces for defining a plurality of attributes for the existing reservation for the item to be rented, wherein the plurality of attributes comprises one or more default start datetimes, one or more default end datetimes, one or more alternative start datetimes, and one or more alternative end datetimes for the item to be rented; a customer module providing one or more customer interfaces for modifying one or more attributes of the existing reservation for the item to be rented; and a database engine facilitating communication between the computer-executable components stored in the memory and one or more databases, wherein the one or more databases comprises: an agent database for storing data related to one or more agents associated with an existing reservation for an item to be rented; an item database for storing data related to an existing reservation for an item to be rented; a customer database for storing data related to one or more customers having an existing reservation for an item to be rented; a transactions database for storing data related to the modification of an existing reservation for an item to be rented; wherein the computer-executable components further comprise instructions for performing a method described herein is provided.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a block diagram of a computing system, in accordance with some embodiments described herein;

FIG. 2 is a block diagram of the application platform in the computing system of FIG. 1;

FIG. 3 is a block diagram of the application platform of FIG. 2;

FIG. 4 is a flow diagram for an agent, in accordance with some embodiments described herein;

FIG. 5 is a flow diagram for a customer, in accordance with some embodiments described herein;

FIG. 6 a graphical user interface according to some embodiments described herein; and

FIG. 7 a graphical user interface according to some embodiments described herein.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

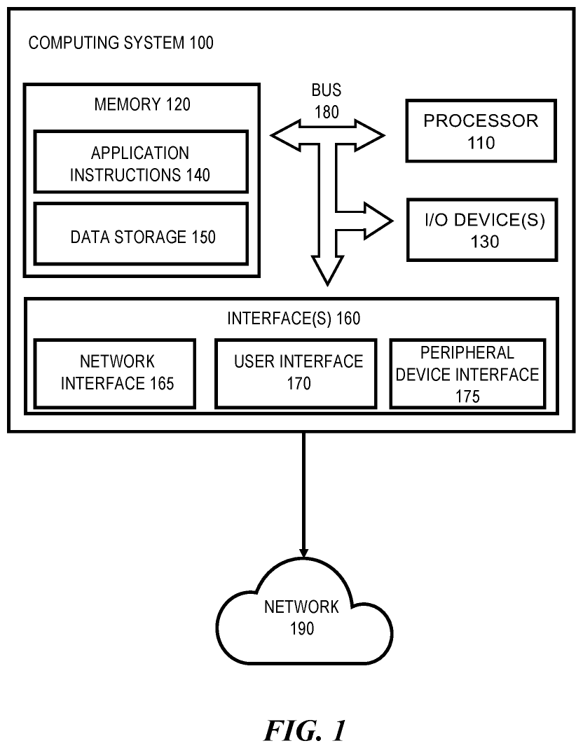

As shown in FIGS. 1-7, the various embodiments in this disclosure generally relate to computer-implemented methods, and systems for performing the same, related to the modification of an existing reservation for a good or service (item).

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processor(s) 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processor(s) 110 suitable for the execution of computer readable program instructions include both general and special purpose microprocessors and any one or more processors of any digital computing device. For example, each processor 110 may be a single processing unit or a number of processing units, and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithread execution capability, multi-core processors, multi-core processors with software multithread execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). In some embodiments, for example, when the item to be rented is software such as a SaaS platform, the term “rented” can refer to a license agreement for a period of time between the customer and agent for the software product.

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

As used herein, the term “datetime” refers to a specific time of a specific day. For example, 10:00 AM on March 17 is a specific time on a specific day (i.e., datetime). This term is more specific than the term “time,” which refers to any day. For example, 10:00 AM occurs every day (i.e., time).

As used herein, the term “agent” refers to a person or entity offering an item for rent. The person or entity can be an owner, consignee, or custodian of the item for rent.

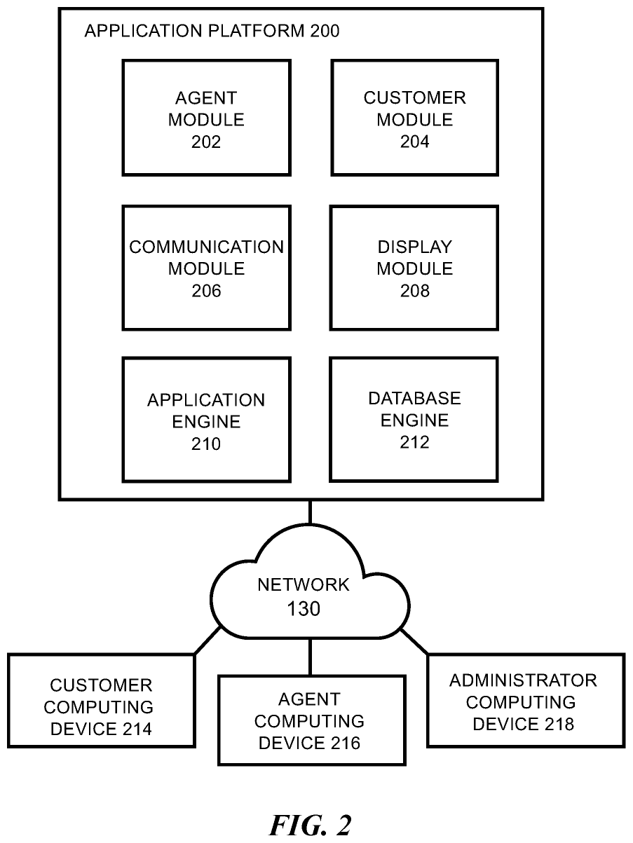

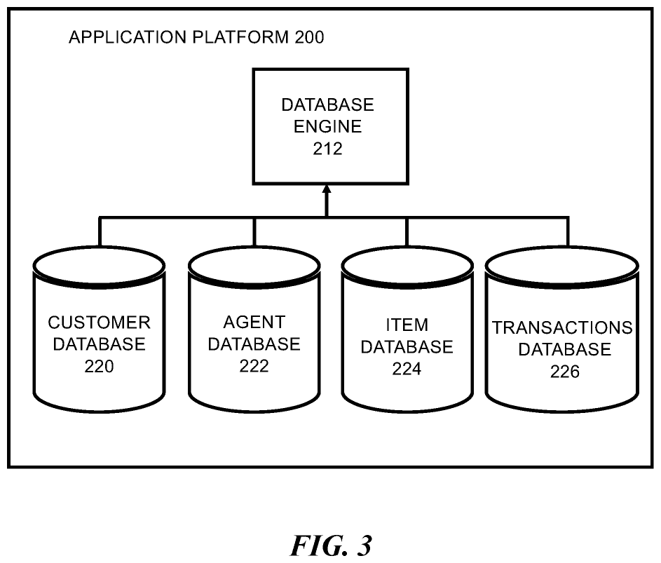

FIGS. 2 and 3 illustrate an example computer architecture for the application platform 200 that facilitates the modification of an existing reservation for the rental of an item. As shown in the figures, the computer system 100 is coupled via a network 190 to a plurality of databases, including a customer database 220, an agent database 222, an item database 224, and a transactions database 226. The computer system 100 comprises several modules and engines configured to facilitate the modification of an existing reservation for the rental of an item, and a database engine 220 configured to facilitate the storage and management of data. In particular, FIG. 2 is a block diagram showing the modules and engines needed to perform specific tasks within the application platform 200, and FIG. 3 is a block diagram showing the various databases utilized by the various modules.

In some embodiments, the customer database 220 contains stored data related to customers who have registered to use the application platform 200. In such embodiments, the customer database 220 stores usernames, login information, customer profile information, as well as any other information supplied by a user, such as payment methods for paying for the modification of a rental start datetime and/or rental end datetime for one or more items that have been reserved for rental.

In some embodiments, the agent database 222 contains stored data related to agents who have registered for a service provided by the system and application platform 200. In such embodiments, the agent database 222 stores usernames, login information, agent profile information, agent property or service information, and agent settings with respect to one or more start and end datetimes for an item offered for rent. Because the application platform 200 allows an agent to dynamically set different start/end times for any number of days, weeks, months in each year, the agent database 222 further stores any default settings inputted by the agent. In such embodiments, the agent will input each property or service offered for rent, and one or more start and end times for each item. In this context, an agent registered with the system to offer alternative rental start/end datetimes for a particular rental period (e.g., January 1-14) for a particular renter can further set a standard rental start or end datetime for everyday of the year, or a default start or end datetime for one or more specific days (e.g., each Monday or holiday), or a default start or end datetime for one or more group of days (e.g., weekdays, weekend days).

In some embodiments, the item database 224 contains stored data related to items for rent that have been inputted into the system by agents. In some embodiments, the data relates to information associated with the item. For example, if the item is real property offered for rent as lodging, then the information may include a description of the property (e.g., photos, text), the location of the property, and standard rental start/end times, default rental start/end datetimes, or alternative rental start/end datetimes for a specific day or group of days. If the item is property other than real property, such as tool or construction equipment, then the information may include a description of the property (e.g., photos, text), one or more locations where the property can be retrieved and/or returned, and standard rental start/end times, default rental start/end datetimes, or alternative rental start/end datetimes for a specific day or group of days. If the item is a service, the information may include a description of the service (e.g., photos, text), a region where the service is offered (e.g., catering service offered only within city limits), and standard rental start/end times, default rental start/end datetimes, or alternative rental start/end datetimes for a specific day or group of days. In some embodiments, the service is an online service, such as an educational class, a tutoring service, a SaaS service, and the information may include standard rental start/end times, default rental start/end datetimes, or alternative rental start/end datetimes for a specific day or group of days.

In some embodiments, the transactions database 226 contains stored data related to a transaction carried out through application platform 200. In some embodiments, the data relates to information related to past, present, and future rentals, including any modifications to the rental start or end datetimes. In some embodiments, the data relates to any communications between a customer and agent generated as a result of a transaction carried out through application platform 200. In some embodiments, the data relates to information associated with the payment of one or more fees for a specific modified rental start or end datetime. In some embodiments, such payment data can be organized and retrieved in a manner that is useful for accounting, auditing, trends, averages, or any other purpose.

Referring to FIG. 2, the application platform 200 comprises a plurality of modules having the necessary routines and data structures for performing specific tasks. In some embodiments, the application platform 200 comprises one or more of an agent module 202, a customer module 204, a communications module 206, an display module 208, an application engine 210, and a database engine 212.

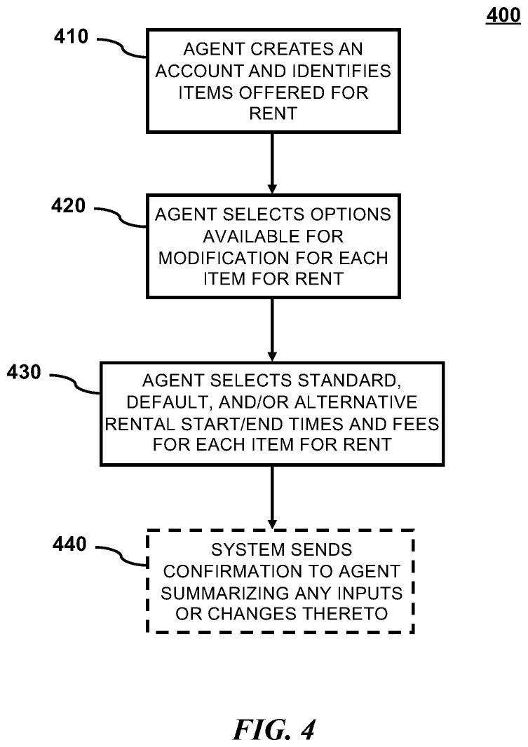

In some embodiments, the agent module 202 is configured to facilitate the deployment of one or more agent interfaces on the agent computing device 216 for interacting with the application platform 200 as well as to facilitate the registration of an agent with the system. An outline of the process 400 is shown in FIG. 4. In step 410, the agent creates an account on the system and identifies one or more items that are available for rent and that will have alternative rental start datetime and/or end datetimes. If the agent has already used the system and previously created an account, then step 410 merely requires the agent to log into the system using a previously created username and password. In step 420, the agent inputs and/or selects through a user interface which options will be available for modification for each item inputted into the agent account. In some embodiments, one or more predetermined options for each item will include modifying the rental start datetime, modifying the rental end datetime, or modifying each of the rental start datetime and the rental end datetime. In step 430, the agent inputs and/or selects through a user interface, for the selected option for one or more selected items, a standard rental start, a standard end time, a default rental time start, a default end time, and/or one or more alternative rental start times or alternative end times for all days of the year, for a specific day, or for a group of days. Optionally, as indicated with the broken lines in FIG. 4, the system transmits a communication (e.g., email, text, mobile application notice) to the agent summarizing the inputs, selections, and/or changes to any settings for an item in step 440.

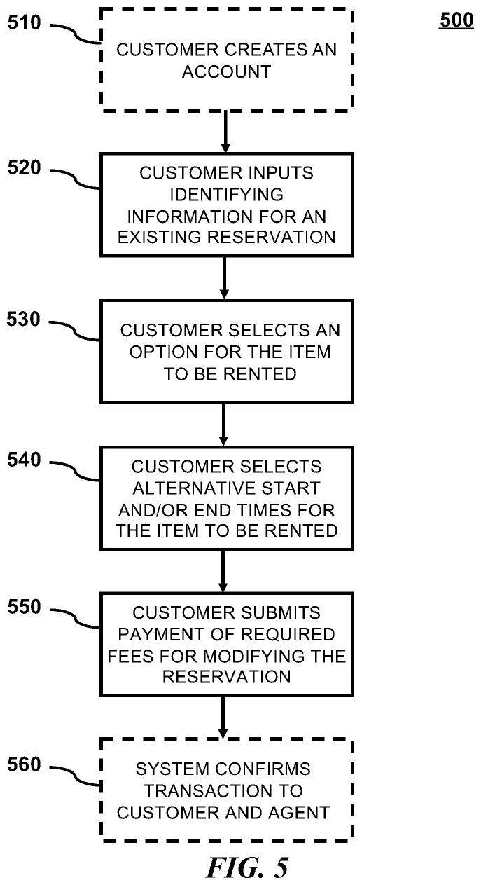

In some embodiments, the customer module 204 is configured to facilitate the deployment of one or more customer interfaces on the customer computing device 214 for interacting with the application platform 200 as well as to facilitate the registration of a customer having an existing reservation with the system. An outline of the process 500 is shown in FIG. 5. Optionally, in step 510, the customer creates an account on the system. In some embodiments, in which the system is implemented as an add-on and integrated into an existing platform offered through a third-party website, the customer will presumably have an account and step 510 will merely involve a login into the system using a previously created username and password. In some embodiments, in which the system is implemented as a stand-alone, non-integrated platform as a web or mobile application, the customer will need to create an account on the system. In such embodiments, the customer inputs and/or selects through a user interface information relevant for carrying out the functions described herein, including a plurality of customer attributes such as name, billing address, email address, telephone number, and payment method.

In step 520, the customer inputs and/or selects through a user interface information identifying the existing reservation for the item to be rented. Such information can include, for example, a confirmation number, agent information, or property information. In step 530, the customer selects through the user interface an option from one or more options available for the particular item to be rented. In such embodiments, the available options are predetermined by the agent in step 420. Such options include modifying the rental start datetime, modifying the rental end datetime, or modifying each of the rental start datetime and the rental end datetime. In step 540, depending on the options available and the option selected, the customer selects one or more of an alternative rental start datetime and an alternative rental end datetime. In step 550, the customer submits payment for any fee required for the selected modifications to the existing reservation. In some embodiments, the required fee is zero, and no payment is required. In some embodiments, the required fee is not zero, and the payment of the required fee is necessary. Optionally, as indicated with the broken lines in FIG. 5, the system, in step 560, transmits a communication (e.g., email, text, mobile application notice) to the customer summarizing the customers modification to the existing reservation. Alternatively, in step 560, the system displays an indication to the customer that the transaction has been received into processing (e.g., a notice of confirmation displayed on a mobile application).

In some embodiments, the communications module 206 is configured to manage communications between components and engines in the computer system 100, the application platform 200, and one or more third party computer systems. In such embodiments, the one or more third party computer systems include, e.g., banking computer systems utilized. To facilitate communication, the communication module 206 may be equipped with hardware and/or software required to enable communication, such as, e.g., a receiver, a transmitter, or both.

In some embodiments, the display module 208 is configured to display one or more agent interfaces, one or more customer interfaces, and/or one or more administrator interfaces. In some embodiments, the display module 208 is configured to temporarily generate and display various pieces of information in response to one or more commands or operations. The various pieces of information or data generated and displayed may be transiently generated and displayed, and the displayed content in the display module 208 may be refreshed and replaced with different content upon the receipt of different commands or operations in some embodiments. In such embodiments, the various pieces of information generated and displayed in a display module 208 may not be persistently stored.

In some embodiments, the system 100 is integrated into the agent's web application or mobile application. In such embodiments, the processes described herein, including the payment of the required fee in step 550, will occur through the agent's web or mobile application. In some embodiments, the system is not integrated with the agent's web or mobile application. In such embodiments, the system 100 and application platform 200 are independent from the agent's systems, and the processes described herein, including the payment of the required fee in step 550 will occur through the system administrator's web or mobile application 218.

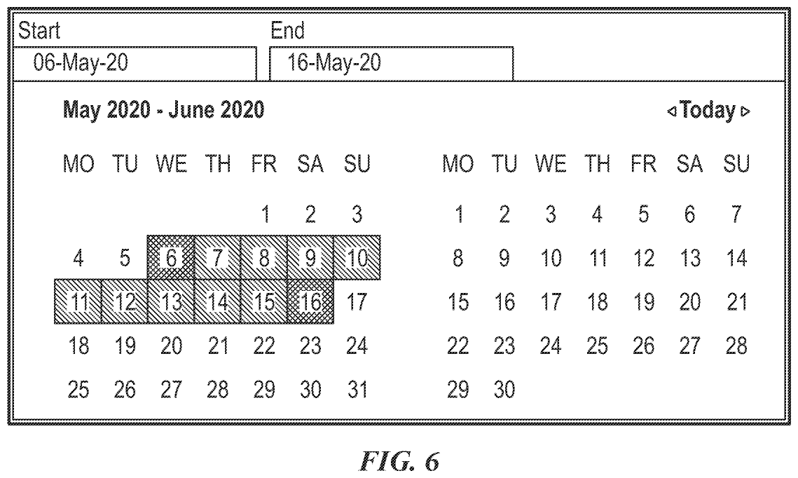

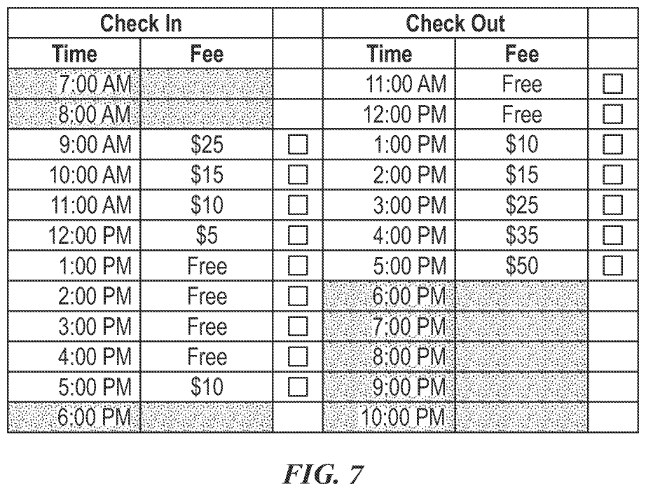

Exemplary user interfaces for the system 100 are shown in FIGS. 6 and 7. In some embodiments, the system includes a user interface as shown in FIG. 6, comprising a calendar view spanning several weeks as well as a search window for a particular start date and a particular end date. Other calendar views are contemplated, including yearly, monthly, and weekly views. In some embodiments, the example shown in FIG. 6 is a customer interface, and the customer can view the period for their existing reservation, or a period of days for which they may want to modify. In the example, the days of May 6, 2020 through May 16, 2020 are shaded to indicate the span of the rental period, whereby the rental start date is May 6, 2020 and the rental end date is May 16, 2020. In some embodiments, the customer can enter in a text field the start date (May 6, 2020) and/or the end date (May 16, 2020) to initiate a process of modifying one or more datetimes. In some embodiments, the interface is an agent interface, and in the example shown in FIG. 6, the span of shaded days represents a time period the agent has selected to edit. In such embodiments, the agent can select any desired span of dates for the purpose of setting a standard start/end time for the year, a default start/end time for specific days or group of days, or a specific start/end datetime for an individual day. In some embodiments, the agent can select an individual item or a plurality of items for datetime modification. For example, the agent interface shown in FIG. 6 can further include an option for selecting the items associated with the agent's account. Alternatively, the system can present a different agent interface, prior to or after the interface shown in FIG. 6, where the user can identify, input, or select one or more items for rent associated with the agent's account.

FIG. 7 shows another user interface for a day. In some embodiments, FIG. 7 is a customer interface showing the rental start time (Check In) and the rental end time (Check Out) for the rental reservation are each shown on a single webpage. Other configurations are contemplated, including, for example, a user interface that shows only the rental start day options or only the rental end day options. In some embodiments, the customer interface includes a list of available alternative rental start times, end times, or both, for the relevant start day and end day in the rental period. In some embodiments, a fee associated with each entry in the list of available alternative start times, end times, or both is included in the customer interface. In some embodiments, a first customer interface includes a list of alternative start times on a single page, and a second customer interface includes a list of alternative end times on a single page. In some embodiments, the first customer interface and second customer interface can further include a fee for each start time or end time. In some embodiments, the features from the first and second customer interfaces are merged into a single customer interface.

In some embodiments, the user interface is an agent interface that is configured to facilitate a designation of the available time periods for an alternative start time or alternative end time for an existing reservation. In FIG. 7, for example, the periods beginning at 1 PM, 2 PM, 3 PM, and 4 PM are designated “Free.” This means that the default start time for a rental beginning on that day has been defined as one of those time periods (e.g., 2 PM) and the other options are available to a customer for no fee. The agent interface also includes earlier start times (9 AM, 10 AM, 11 AM, and 12 PM), and an additional start time later in the day at 5 PM. The periods beginning at 7 AM, 8 AM, and 6 PM are shaded to indicate that the start time cannot be modified to those time periods. In some embodiments, the agent interface is configured to allow the dynamic modification of the available rental start times for a particular day and the fee associated with each time period. As shown in the figure, the available time periods include an open box adjacent to the fee amounts for the inclusion or non-inclusion of that particular time period. In some embodiments, the agent interface is configured to allow the agent to select the fee amount for, e.g., 9 AM, and the interface will provide the agent with alternative amounts of fee amounts for selection or indicate that the amount should be typed in.

In some embodiments, the user interface is a customer interface that is configured to facilitate the modification of a rental start time or rental end time. In FIG. 7, the time periods beginning at 7 AM, 8 AM, and 6 PM are shaded to indicate that the start time cannot be modified to those time periods, and the time periods beginning at 9 AM through 5 PM are available as alternative start times. In some embodiments, the customer interface indicates the fee amount associated with each available time period. Similarly, the customer interface provides an option for modifying the rental end time (designated “Check Out” in FIG. 7). In this example, the customer can end the rental for free until the time period beginning at 1 PM, and pay the predetermined fee amount for the alternative end times beginning at 1 PM though 5 PM. The time periods beginning at 6 PM or after are shaded to indicate that the start time cannot be modified to those time periods.

In some embodiments, a link to the user interface shown in FIG. 6 and/or the user interface shown in FIG. 7, can be transmitted from an agent to a customer via email or text message. For example, if a customer contacts (e.g., telephone call, email, text) an agent regarding how early they can check in or how late they can check out, then the agent can respond to the customer with one or more links designated to that feature of the device. In some embodiments, for example when the system has been integrated into a website for an agent, the integrated website can include a button, linking text, or some other interactive component that connects the customer to the user interface shown in FIG. 6 and/or the user interface shown in FIG. 7.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart, illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Web browsers and/or the like. Each application generally has its own user interface that allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a windo) and buttons (which can be “pushed” with a click of a mouse). A wide variety of applications is known by those having ordinary skill in the art.

The phrases “Application Program interface” and API as are used herein mean a set of commands, functions and/or protocols that computer programmers can use when building software for a specific operating system. The API allows programmers to use predefined functions to interact with an operating system, instead of writing them from scratch. All computer operating systems, such as Windows, Unix, and the Mac OS, usually provide an application program interface for programmers. APIs are also used by hardware devices that can run software programs. While the API makes the programmer's job easier, it also benefits the end user, since it generally ensures that all programs using the same API with have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A computer implemented method, comprising:
receiving, by a computing system, an indication that a customer wants to electronically modify an existing reservation for an item to be rented;
requesting, by the computing system, the customer to provide a customer identifier, wherein the customer identifier includes one or more attributes for the customer having the existing reservation;
requesting, by the computing system, the customer to provide a reservation identifier, wherein the reservation identifier includes one or more attributes for the item to be rented, including name, rental start datetime, rental end datetime, confirmation number, agent information, information of the item to be rented and information identifying the existing reservation;
identifying, by the computing system, the existing reservation for the item to be rented based at least on the reservation identifier;
selecting, by the computing system, one or more predetermined options for modifying the one or more attributes for the item to be rented corresponding to the existing reservation, wherein the one or more predetermined options include modifying the rental start datetime, modifying the rental end datetime, and modifying the rental start datetime and the rental end datetime;
requesting, by the computing system, the customer to select at least one of the one or more predetermined options for modifying the one or more attributes for the item to be rented;
receiving, by the computing system, an indication that the customer selected at least one of the one or more predetermined options;
identifying, by the computing system, based on the selected one or more predetermined options, one or more alternatives for modifying the existing reservation, the one or more alternatives for modifying the existing reservation including one or more alternative start datetimes, one or more alternative end datetimes, or one or more alternative start datetimes and one or more alternative end datetimes;
dynamically modifying, by the computing system, at least one of the one or more alternatives for modifying the existing reservation;
presenting, by the computing system, an interface to the customer, the interface corresponding to the selected one or more predetermined options, wherein the interface includes a feature providing at least one of the one or more alternatives for modifying the existing reservation;
receiving, by the computing system, an input from the customer indicating that an alternative start datetime of the one or more alternative start datetimes has been selected, that an alternative end datetime of the one or more alternative end datetimes has been selected, or that an alternative end datetime of the one or more alternative start datetimes and an alternative end datetime of the one or more alternative end datetimes have been selected;
requesting, by the computing system, a payment from the customer, if required, for the selected alternative start datetime, the selected alternative end datetime, or the selected alternative start and the selected alternative end datetimes;
confirming, by the computing system, if required, receipt of the payment; and
modifying by the computing system, the existing reservation, including at least modifying one of the one or more attributes for the real state to be rented, based at least on one of the alternative start datetime that was selected, the alternative start datetime that was selected, and the alternative start datetime and the alternative end datetime that were selected;
wherein the interface further comprises a graphical user interface that allows dynamic modification of available rental start times, available rental end times, or both available rental start times and available rental end times, for a particular day and the fee associated with each time period by displaying to the customer a full range of possible start, end, or start and end time adjustments to the rental period in a particular manner that does not require first contacting an agent to review and discuss the modification request, the agent being associated with the item to be rented;
wherein, the graphical user interface includes an agent interface that is configured to facilitate designation of the available time periods for an alternative start time or alternative end time for an existing reservation, including time periods designated as free having default start times for a rental which are available to the customer for no fee, and earlier start times, and additional later start times, and shaded periods which indicate that the start time cannot be modified to those time periods, such that the user interface shows the available time periods and includes an open box adjacent to the fee amounts for the inclusion or non-inclusion of that particular time period; and wherein the agent interface is configured to allow the agent to select the fee amount for a time period and the interface will provide the agent with alternative amounts of fee amounts for selection or indicate that the amount should be typed in; and
wherein, the graphical user interface includes a customer interface that is configured to facilitate modification of a rental start time or rental end time, wherein the customer interface includes shaded time periods which indicate that the shaded start time cannot be modified to those time periods and time periods which are available as alternative start times;
and wherein the customer interface also indicates the fee amount associated with each available time period, and wherein the customer interface provides an option for modifying the rental end time check out, wherein a customer can end the rental for free or pay a predetermined fee amount for alternative end times which are shown in the interface, and wherein the shaded start time periods which are shown in the customer interface cannot be modified by the customer.

2. The computer implemented method of claim 1, further comprising providing, by the computing system, a communication to the customer and the agent associated with the item to be rented, wherein the communication includes information confirming the existing reservation has been modified, and wherein the communication further comprises information identifying the one or more attributes that have been modified.

3. The computer implemented method of claim 1, wherein each of the one or more alternative start datetimes and each of the one or more alternative end datetimes has an associated fee that is, independent from one another, the same or different than a fee associated with any other alternative start datetime or alternative end datetime for the item to be rented.

4. The computer implemented method of claim 1, wherein the one or more predetermined options are predetermined by the agent associated with the item to be rented.

5. The computer implemented method of claim 1, wherein each of the rental start datetime, the rental end datetime, the one or more alternative start datetimes, and the one or more alternative end datetimes is, independent from one another, predetermined by the agent associated with the item to be rented.

6. The computer implemented method of claim 1, wherein each of the rental start datetime, the rental end datetime, the one or more alternative start datetimes, and the one or more alternative end datetimes is, independent from one another, identical or different for each day of a year.

7. The computer implemented method of claim 1, wherein each of the rental start datetime, the rental end datetime, the one or more alternative start datetimes, and the one or more alternative end datetimes is, independent from one another, identical or different for each item to be rented.

8. (canceled)

9. The computer implemented method of claim 1, further comprising:
creating, by the computing system, the existing reservation through a web application or a mobile application.

10. The computer implemented method of claim 9, further comprising: allowing, by the computing system, the customer to manage the existing reservation through the web application or the mobile application.

11. A computer program product comprising a non-transitory computer readable storage medium having program instructions embodied therewith, the program instructions executable by a computer processor to cause the computer processor to perform a method, comprising:
receiving, by a computing system, an indication that a customer wants to electronically modify an existing reservation for an item to be rented;
requesting, by the computing system, the customer to provide a customer identifier, wherein the customer identifier includes one or more attributes for the customer having the existing reservation;
requesting, by the computing system, the customer to provide a reservation identifier, wherein the reservation identifier includes one or more attributes for the item to be rented, including name, rental start datetime, rental end datetime, confirmation number, agent information, information of the item to be rented and information identifying the existing reservation;
identifying, by the computing system, the existing reservation for the item to be rented based at least on the reservation identifier;
selecting, by the computing system, one or more predetermined options for modifying the one or more attributes for the item to be rented corresponding to the existing reservation, wherein the one or more predetermined options include modifying the rental start datetime, modifying the rental end datetime, and modifying the rental start datetime and the rental end datetime;
requesting, by the computing system, the customer to select at least one of the one or more predetermined options for modifying the one or more attributes for the item to be rented,
receiving, by the computing system, an indication that an option of the one or more predetermined options has been selected;
identifying, by the computing system, based on the selected one or more predetermined options, one or more alternatives for modifying the existing reservation, the one or more alternatives for modifying the existing reservation including one or more alternative start datetimes, one or more alternative end datetimes, or one or more alternative start datetimes and one or more alternative end datetimes;
dynamically modifying at least one of the one or more alternatives for modifying the existing reservation;
presenting, by the computing system, an interface to the customer, the interface corresponding to the selected one or more predetermined options, wherein the interface includes a feature providing at least one of the one or more alternatives for modifying the existing reservation;
receiving, by the computing system, an input from the customer indicating that an alternative start datetime of the one or more alternative start datetimes has been selected, that an alternative end datetime of the one or more alternative end datetimes has been selected, or that an alternative end datetime of the one or more alternative start datetimes and an alternative end datetime of the one or more alternative end datetimes have been selected;
requesting, by the computing system, a payment from the customer, if required, for the selected alternative start datetime, the selected alternative end datetime, or the selected alternative start and the selected alternative end datetimes;
confirming, by the computing system, if required, receipt of the payment; and
modifying, by the computing system, the existing reservation, including at least modifying one of the one or more attributes for the real state to be rented, based at least on one of the alternative start datetime that was selected, the alternative start datetime that was selected, and the alternative start datetime and the alternative end datetime that were selected;
wherein the interface further comprises graphical user interface that allows dynamic modification of available rental start times, available rental end times, or both available rental start times and available rental end times, for a particular day and the fee associated with each time period by displaying to the customer a full range of possible start, end, or start and end time adjustments to the rental period in a particular manner that does not require first contacting an agent to review and discuss the modification request, the agent being associated with the item to be rented;
wherein, the graphical user interface includes an agent interface that is configured to facilitate designation of the available time periods for an alternative start time or alternative end time for an existing reservation, including time periods designated as free having default start times for a rental which are available to the customer for no fee, and earlier start times, and additional later start times, and shaded periods which indicate that the start time cannot be modified to those time periods, such that the user interface shows the available time periods and includes an open box adjacent to the fee amounts for the inclusion or non-inclusion of that particular time period; and wherein the agent interface is configured to allow the agent to select the fee amount for a time period and the interface will provide the agent with alternative amounts of fee amounts for selection or indicate that the amount should be typed in; and
wherein, the graphical user interface includes a customer interface that is configured to facilitate modification of a rental start time or rental end time, wherein the customer interface includes shaded time periods which indicate that the shaded start time cannot be modified to those time periods and time periods which are available as alternative start times; and wherein the customer interface also indicates the fee amount associated with each available time period, and wherein the customer interface provides an option for modifying the rental end time check out, wherein a customer can end the rental for free or pay a predetermined fee amount for alternative end times which are shown in the interface, and wherein the shaded start time periods which are shown in the customer interface cannot be modified by the customer.

12. The computer program product of claim 11, wherein the method further comprises: providing, by the computer processor, a communication to the customer and an agent associated with the item to be rented, wherein the communication includes information confirming the existing reservation has been modified, and wherein the communication further comprises information identifying the one or more attributes that have been modified.

13. The computer program product of claim 11, wherein each of the one or more alternative start datetimes and each of the one or more alternative end datetimes has an associated fee that is, independent from one another, the same or different than a fee associated with any other alternative start datetime or alternative end datetime for the item to be rented.

14. The computer program product of claim 11, wherein the one or more predetermined options are predetermined by an agent associated with the item to be rented.

15. The computer program product of claim 11, wherein each of the rental start datetime, the rental end datetime, the one or more alternative start datetimes, and the one or more alternative end datetimes is, independent from one another, predetermined by an agent associated with the item to be rented.

16. The computer program product of claim 11, wherein each of the rental start datetime, the rental end datetime, the one or more alternative start datetimes, and the one or more alternative end datetimes is, independent from one another, identical or different for each day of a year.

17. The computer program product of claim 11, wherein each of the rental start datetime, the rental end datetime, the one or more alternative start datetimes, and the one or more alternative end datetimes is, independent from one another, identical or different for each item to be rented.

18. (canceled)

19. The computer program product of claim 11, wherein the method further comprises: creating, by the computer processor, the existing reservation through a web application or a mobile application; and allowing, by the computer processor, the customer to manage the existing reservation through the web application or the mobile application.

20. A computer system for modifying an existing reservation for an item to be rented, comprising:
a memory that stores computer-executable components containing program instructions;
a processor coupled to the memory and operable to execute the program instructions in the computer-executable components stored in the memory, wherein the computer-executable components comprise:
an agent module and a customer module providing one or more interfaces,
wherein the one or more interfaces from the agent module enable defining a first plurality of attributes of the existing reservation for the item to be rented, wherein the first plurality of attributes comprises one or more default start datetimes, one or more default end datetimes, one or more alternative start datetimes, and one or more alternative end datetimes for the item to be rented, and wherein the one or more interfaces from the customer module enable modifying one or more of the first plurality of attributes of the existing reservation for the item to be rented; and
a database engine facilitating communication between the computer-executable components stored in the memory and one or more databases in the system, wherein the one or more databases comprises:
an agent database for storing data related to one or more agents associated with the existing reservation for an item to be rented;
an item database for storing data related to the existing reservation for the item to be rented;
a customer database for storing data related to a customer having the existing reservation for the item to be rented;
a transactions database for storing data related to modification of the existing reservation for the item to be rented;
wherein the program instructions in the computer-executable components, upon execution by the processor, cause the processor to implement a method comprising:
receiving an indication that the customer wants to electronically modify the existing reservation for the item to be rented;
requesting the customer to provide a customer identifier, wherein the customer identifier includes a second plurality of attributes for the customer having the existing reservation;
requesting the customer to provide a reservation identifier, wherein the reservation identifier includes a third plurality of attributes for the item to be rented, including item name, rental start datetime, and rental end datetime;
identifying the existing reservation for the item to be rented based at least on the reservation identifier;
selecting one or more predetermined options for modifying the one or more attributes for the item to be rented corresponding to the existing reservation, wherein the one or more predetermined options include modifying the rental start datetime, modifying the rental end datetime, and modifying the rental start datetime and the rental end datetime;
requesting the customer to select at least one of the one or more predetermined options for modifying one or more of the third plurality of attributes for the item to be rented;
receiving an indication that the customer selected at least one of the one or more predetermined options;
identifying, based on the selected one or more predetermined options, one or more alternatives for modifying the existing reservation, the one or more alternatives for modifying the existing reservation including one or more alternative start datetimes, one or more alternative end datetimes, or one or more alternative start datetimes and one or more alternative end datetimes,
dynamically modifying at least one of the one or more alternatives for modifying the existing reservation;
presenting an interface to the customer, the interface corresponding to the selected one or more predetermined options, wherein the interface includes a feature providing at least one of the one or more alternatives for modifying the existing reservation;
receiving an input from the customer indicating that an alternative start datetime of the one or more alternative start datetimes has been selected, that an alternative end datetime of the one or more alternative end datetimes has been selected, or that an alternative end datetime of the one or more alternative start datetimes and an alternative end datetime of the one or more alternative end datetimes have been selected;
requesting a payment from the customer, if required, for the selected alternative start datetime, the selected alternative end datetime, or the selected alternative start and the selected alternative end datetimes;
confirming, if required, receipt of the payment;
modifying the existing reservation, including at least modifying one of the one or more attributes for the real state to be rented, based at least on one of the alternative start datetime that was selected, the alternative start datetime that was selected, and the alternative start datetime and the alternative end datetime that were selected;
wherein the one or more interfaces further comprise a graphical user interface that allows dynamic modification of available rental start times, available rental end times, or both available rental start times and available rental end times, for a particular day and the fee associated with each time period by displaying to the customer a full range of possible start, end, or start and end time adjustments to the rental period in a particular manner that does not require first contacting the agent to review and discuss the modification request;
wherein, the graphical user interface includes an agent interface that is configured to facilitate designation of the available time periods for an alternative start time or alternative end time for an existing reservation, including time periods designated as free having default start times for a rental which are available to the customer for no fee, and earlier start times, and additional later start times, and shaded periods which indicate that the start time cannot be modified to those time periods, such that the user interface shows the available time periods and includes an open box adjacent to the fee amounts for the inclusion or non-inclusion of that particular time period; and wherein the agent interface is configured to allow the agent to select the fee amount for a time period and the interface will provide the agent with alternative amounts of fee amounts for selection or indicate that the amount should be typed in; and
wherein, the graphical user interface includes a customer interface that is configured to facilitate modification of a rental start time or rental end time, wherein the customer interface includes shaded time periods which indicate that the shaded start time cannot be modified to those time periods and time periods which are available as alternative start times;
and wherein the customer interface also indicates the fee amount associated with each available time period, and wherein the customer interface provides an option for modifying the rental end time check out, wherein a customer can end the rental for free or pay a predetermined fee amount for alternative end times which are shown in the interface, and wherein the shaded start time periods which are shown in the customer interface cannot be modified by the customer.

21. A computer implemented method, comprising:
receiving, by a computing system, an indication that a customer wants to electronically modify an existing reservation for a real estate to be rented;
requesting, by the computing system, the customer to provide a customer identifier, wherein the customer identifier includes one or more attributes for the customer having the existing reservation;
requesting, by the computing system, the customer to provide a reservation identifier, wherein the reservation identifier includes one or more attributes for the real estate to be rented, including name, rental start datetime, and rental end datetime;
requesting, by the computing system, the customer to select one or more predetermined options for modifying the one or more attributes for the real estate to be rented, wherein the one or more predetermined options include modifying the rental start datetime, modifying the rental end datetime, and modifying the rental start datetime and the rental end datetime;
receiving, by the computing system, an indication that an option of the one or more predetermined options has been selected,
presenting, by the computing system, an interface to the customer for the selected option, wherein the interface includes a feature providing one or more alternative start datetimes, a feature providing one or more alternative end datetimes, or a feature providing one or more alternative start datetimes and one or more alternative end datetimes;
receiving, by the computing system, an input from the customer indicating that an alternative start datetime of the one or more alternative start datetimes has been selected, that an alternative end datetime of the one or more alternative end datetimes has been selected, or that an alternative end datetime of the one or more alternative start datetimes and an alternative end datetime of the one or more alternative end datetimes have been selected;
requesting, by the computing system, a payment from the customer, if required, for the selected alternative start datetime, the selected alternative end datetime, or the selected alternative start and the selected alternative end datetimes;
confirming, by the computing system, receipt of the payment;
allowing, by the computing system, the customer to electronically modify the existing reservation; and said interface further comprising a structured graphical user interface that allows dynamic modification of available rental start times for a particular day and the fee associated with each time period by displaying to the customer a full range of possible start and or end time adjustments to the rental period in a particular manner that does not require first contacting the agent to review and discuss the modification request;
wherein, the structured graphical user interface includes an agent interface that is configured to facilitate designation of the available time periods for an alternative start time or alternative end time for an existing reservation, including time periods designated as free having default start times for a rental which are available to the customer for no fee, and earlier start times, and additional later start times, and shaded periods which indicate that the start time cannot be modified to those time periods, such that the user interface shows the available time periods and includes an open box adjacent to the fee amounts for the inclusion or non-inclusion of that particular time period; and wherein the agent interface is configured to allow the agent to select the fee amount for a time period and the interface will provide the agent with alternative amounts of fee amounts for selection or indicate that the amount should be typed in; and
wherein, the structured graphical user interface includes a customer interface that is configured to facilitate modification of a rental start time or rental end time, wherein the customer interface includes shaded time periods which indicate that the shaded start time cannot be modified to those time periods and time periods which are available as alternative start times; and wherein the customer interface also indicates the fee amount associated with each available time period, and wherein the customer interface provides an option for modifying the rental end time check out, wherein a customer can end the rental for free or pay a predetermined fee amount for alternative end times which are shown in the interface, and wherein the shaded start time periods which are shown in the customer interface cannot be modified by the customer.
